(19) United States
(12) Patent Application Publication
(10) Pub. No.: US 2013/0004986 A1
(43) Pub. Date: Jan. 3, 2013

(54) Use of luminescent Ir(III) and Ru(II) complexes

(76) Inventors: Luisa De Cola, Munster (DE); Jesus Miguel Fernandez Hernandez, Munster (DE); Francesco Paolucci, Noventa Padovana (IT)

(21) Appl. No.: 13/513,703

(22) PCT Filed: Dec. 3, 2010
(86) PCT No.: PCT/EP2010/068900

§ 371 Date: Sep. 14, 2012

(30) Foreign Application Priority Data
Dec. 3, 2009 (GB) 0921201.0

(51) Int. Cl. G01N 21/66; G01N 21/76

(52) U.S. Cl. 435/34; 436/501; 436/139; 436/94; 436/86; 436/172; 436/92

(57) ABSTRACT

The present invention relates to the use of luminescent Ir(III) and Ru(II) complexes and their application in electro-chemiluminescence and bio-labelling. The use refers to the labelling and detection of biomolecules.

### FIELD OF THE INVENTION

The field of the present invention relates to the use of luminescent Ir(III) and Ru(II) complexes and their application in electro-chemiluminescence and bio-labelling.

### BACKGROUND OF THE INVENTION

The EP 1 434 286 discloses an iridium complex with a phenyl pyridine ligand and a dionate chelating ligand. The iridium complexes are used as organic thin films in electroluminescent devices.

The WO 2006/090301 discloses an iridium complex for emitting light. The complex comprises a rigid aromatic ligand with one nitrogen atom and one carbon atom and a dionate chelating ligand.

Slinker et al. published a ruthenium complex with a phenyl pyridine or a bipyridine ligand.

Duati and co-worker published a mononuclear compound [Ru(tertpy)L], where L is 2,6- bis(1,2,4-triazol-3-yl)pyridine.

The U.S. Pat. No. 5,221,605 discloses luminescent metal chelate labels and means for their detection. This document focusses on ruthenium or osmiumcontaining luminescent organ-metallic compounds.

The synthesis of luminescent Ir(III) and Ru(II) complexes have been described by De Cola et al (Chem. Eur. J. 2009, 15, 13124-13134).

All documents mentioned above do not describe the use of luminescent metal complexes with enhanced luminescence in biological applications. Thus, there is a need for luminescent metal complexes, which can be used in aqueous solutions.

### SUMMARY OF THE INVENTION

The present disclosure provides the use of a luminescent complex according to the general formula I

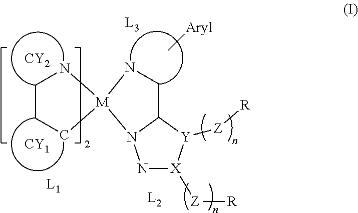

in an aqueous solution, wherein M represents Ru(II) or Ir(III), and L₁ represents a cyclometalating ligand, wherein each of CY₁and CY₂ comprises at least one aromatic and/or aliphatic ring, and L₂ represents triazole, tetrazole or pyrazole, and L₃ represents a pyridine with or without fused and non-fused ring, and X represents C or N, and Y represents C or N, and Z represents C—O—C, an alkyl, aryl, alkynyl, CH═CH, CF₂, and R represents H, a halogen, OH, COOH, C(O)OR′, C(O)NR SO₃⁻, SO₄⁻, NR′₂, NR′₃⁺, OR′, aromatic ring or ring systems, non-aromatic ring or ring systems, heteroaromatic ring or ring systems, imidazolium, cyclodextrin, with R′ representing H, an alkyl or aryl.

It is intended that the cyclometalating ligands are selected from the group comprising pyridine, bipyridine, phenyl-pyridine, phenyl-isoquinoline, 2,4-bisfluor-phenyl-pyridine, or any ligand comprising aryl-heterocyclic aromatic ring and/or an aryl-heterocyclic non-aromatic ring.

For the substituted pyridine-heteroaromatic rings 2-(3-substituted-1H-1,2,4-triazole-5-yl)pyridine, 2-(4-substituted-1,2,3-triazole-4-yl)pyridine or 2-(1-substituted-1,2,3-triazole-4-yl)pyridine may be used. Alternatively the pyridine- heteroaromatic rings is 2-(3-substituted-1H-pyrazole-5-yl)pyridine.

In case that cyclodextrine is used, it is intended that the cyclodextrine is a b-cyclodextrin. Independently of the class of the cyclodextrin which can be used, it might be permethylated.

In a further embodiment of the disclosed use, the complex is coupled to a biological substance, a biological molecule or a synthetic substance or molecule. It is intended that the substances or molecules can be coupled with a hydrophilic chain of the complex.

In another embodiment of the use according to the present disclosure the complex can be coupled to a cell, an antibody, a polypeptide, an amino acid, a deoxyribonucleic acid, a ribonucleic acid, a polysaccharide, an alkaloid, a steroid, a vitamin, a synthetic or biological polymer, or to a synthetic or biological surface.

The use of a complex as described above in a chemi- or electrochemiluminescent device or a chemi or electrochemiluminescent system is also intended, wherein the detection of cells, antibodies, polypeptides, amino acids, deoxyribonucleic acids, ribonucleic acids, polysaccharides, alkaloids, steroids, vitamins, synthetic or biological polymers can be performed using said devices or systems. It is self-understood for a person skilled in the art that said methods can also be performed without the mentioned devices or systems.

The use according to the present disclosure covers also screening, detection, binding or competitive binding assays.

### BRIEF DESCRIPTION OF THE FIGURES

The luminescent complexes will be described by figures and examples, without being limited to the disclosed embodiments. It shows:

FIG. 1 General formula of the complex cover in the patent

FIG. 2 Examples of functionalization of cyclodextrin bCD4

FIG. 3 Examples of Ru (II) complexes.

FIG. 4 Example for the preparation of water soluble Ir complex

FIG. 5 Examples of Ir complex described in this patent.

FIG. 6 Emission and absorbance spectra of C3 in water.

FIG. 7 Emission spectra of C9 in water.

FIG. 8 ECL intensity vs. potential profile in 0.1 M PB/30 mM DBAE. [Ir(III)]=0.1 mM. (1) C4. (2) C1. (3) C5. Image of electrode during emission with specified compound

FIG. 9 Example of synthesis of pyridine-1,2,3-triazole ligands functionalized β-CD with demethylated

FIG. 10 Example of preparation of pyridine-1,2,3-triazole used in the patent,

### DETAILED DESCRIPTION OF THE INVENTION

Within the present disclosure the abbreviations summarized in table 1 will be use:

TABLE 1
Abbreviations of IUPAC names

| IUPAC name | Abbreviation |
|---|---|
| 2-(1-substituted-1H-1,2,3-triazol-4-yl)pyridine | pytl |
| bipyridine | bpy |
| phenyl-pyridine | ppy |
| 2,4-difluorophenylpyridine | F2ppy |
| 1-phenylisoquinoline | piq |
| cyclodextrin | CD |
| methyl | Me |
| adamantane | ada |

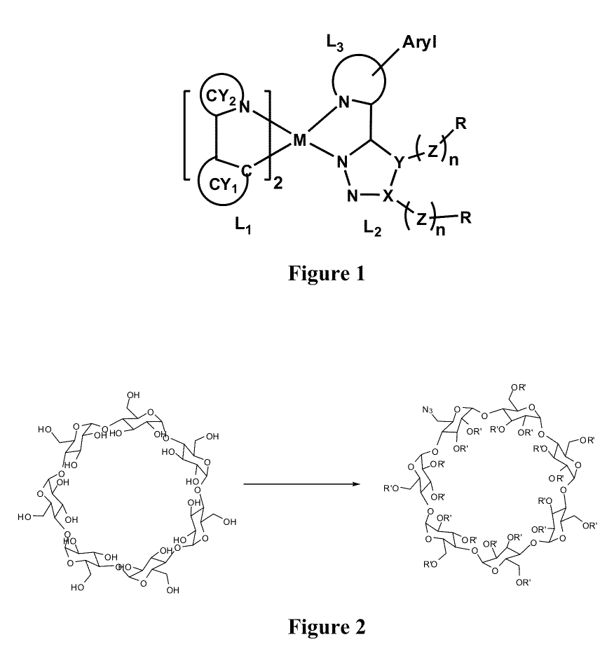

A novel family of metal complexes of general formula (FIG. 1) has been synthesised and used in an electrochemiluminescent (ECL) assay, i.e., chemiluminescence produced by electro-generated species in solution.

The Ir complexes have a cyclometalating ligand (ĈN) based on aryl group bind to the metal atom and an aromatic heterocycle. The third ligand can be any as disclosed in the general formula (L3 and L2).

When L3̂L2=2-(1-substituted-1H-1,2,3-triazol-4-yl)pyridine (pytl) they were synthesized by the Cu-catalyzed dipolar [3+2] cycloaddition, better known as ‘click reaction’. It involves the efficient formation of 1,2,3-triazole rings by coupling terminal alkynes and azides. The established high efficiency and versatility of the click reaction is a key to the success of the research. A library of differently functionalized ligands can be very easily prepared, starting from three different molecules all containing an azide, simply by carrying out the click reaction in presence of 2-ethynyl-pyridine. Applying click chemistry to azide-appended alkyl, aryl, alkenyl substituted and 2-ethynyl-pyridine,_This novel approach is extremely flexible; it allows in principle for the functionalization of any azide-appended molecule with this ligand, as has been shown for 4-butoxyphenylazide as well as for relatively small and large carbohydrates, such as cyclodextrins.

In the case of a mono-functionalized βCD, the pyridine-triazole ligand were synthesised following two strategies, i) leaving the OH groups increasing solubility in water and; ii) methylate the 20 remaining hydroxyl groups; this makes the molecule soluble in a wider range of solvents as well as easier to purify by chromatography, and extends the hydrophobic cavity so that its binding properties are improved.

The preparation of the permethylated mono-pytl-appended βPCD 1 from βCD 4 (FIG. 2) proceeded following a procedure described in the literature (De Cola et al. Chem. Eur. J. 2009, 15, 13124-13134).

Cyclodextrins (CDs) are well-known cyclic oligosaccharides that can form inclusion complexes in aqueous solution with a variety of hydrophobic substrates, such as adamantane-derivatives, and have been widely applied as supramolecular building blocks in various areas including photoactivated electron transfer processes.

The rest of 2-(1-substituted-1H-1,2,3-triazol-4-yl)pyridine ligands were prepared in a similar way by reacting 2-ethynylpyridine with the respective azide derivate.

The pyridine-1,2,4-triazole ligand can be synthesized following the procedure described in the literature, as example WO 2010/07107 A1.

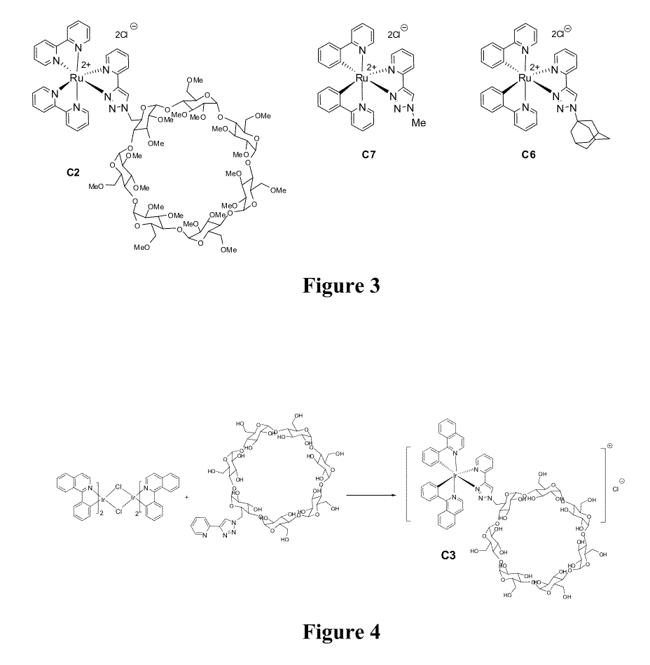

The Ru complexes covered in this patent, can be prepared following the procedure described in the literature De Cola et all Chem. Eur. J. 2009, 15, 13124-13134, by reaction of the [(Ru(bpy)Cl₂] and the ligand, as examples C2, C6 and C7 FIG. 3.

A general way of synthesis of Ir complexes [Ir(ĈN)₂(pytl)]X(ĈN=cyclometalating ligand; X=Cl, is by replacing the bridging chlorides from the Ir(III) chloro-bridged dimer (ĈN)₂Ir(μ−Cl)₂Ir(ĈN)₂ with the corresponding pytl ligands, as shown in FIG. 4 for the new complex with cyclodextrin C3 (FIG. 4).

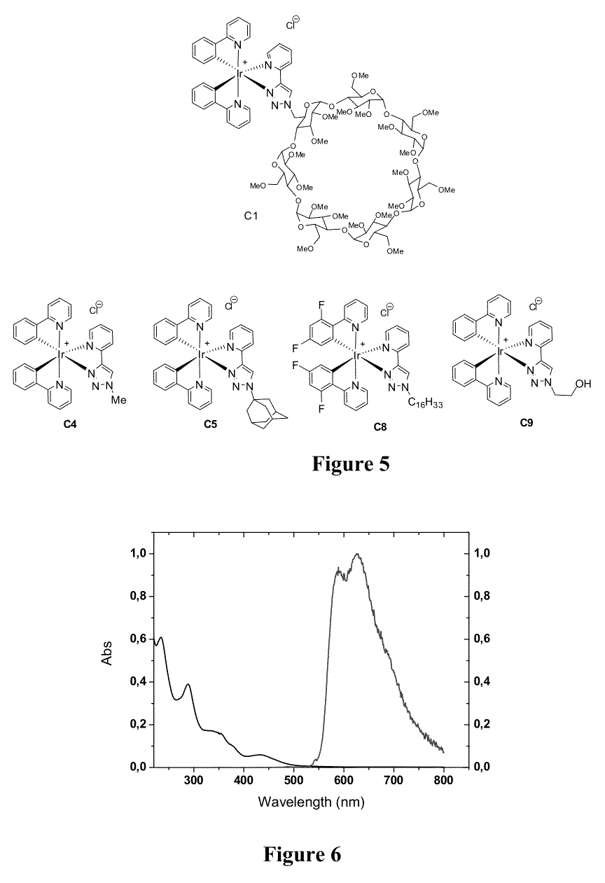

The C1 counterion can be easily replaced by methatesis reaction of the complex with NH₄PF₆, NaBF₄ or NaClO₄. By similar procedure we synthesized the example complexes, C1, C4, C5, C8 and C9 (FIG. 5).

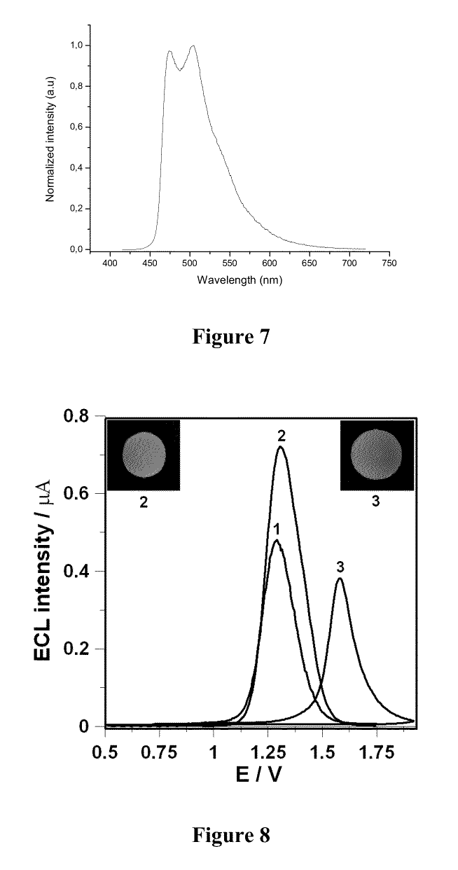

The type of complexes described in this disclosure is water-soluble and displays bright luminescence both in water and organic solvents. Exemplified complexes C1, C2, C3, C5, C6, C7, C9 reach in air equilibrated water solutions quantum yields of 14%, 1%, 10%, 7.6%, 1%, 0.6%, 10% respectively. In the case of the iridium complexes the resolved vibronic structure typical for this type of complexes is observed (see for example FIGS. 6 and 7).

The lowest excited state is also for Ir ³MLCT, however, for such high energy emitting complexes a certain degree of mixing with the ³LC is present. By modifying the substituents on the different ligand it is possible to modulate the emission of the Ir complexes. Fluor substituents at the phenyl rings of the cyclometallating ligands lower the energy of the HOMO orbital in the molecules. The lowering of the LUMO energy is significantly less than for the HOMO, resulting in a widening of the HOMO-LUMO gap and leading to an increase in excited state energy. This is translated to a blue shift of the emission going from the green emitters (non-fluorinated) to the blue emitters (fluorinated complexes). On the other hand, for complex C3 the emission is red shifted compared to complexes with ppy or F2ppy due to a lowering of the LUMO energy caused when pyridine is substituted for a more conjugated aromatic ring (comparation of emission spectra in FIGS. 6 and 7).

Ruthenium complexes exhibit rather short lifetimes and low quantum yields and their photophysical properties therefore are not affected by the presence of dioxygen. The lowest excited state most likely involves the bipyridine ligands due to the fact that the LUMO of the triazole is more electron-rich and therefore higher in energy than the pyridines. In ruthenium complexes containing 1,2,4-triazole-pyridine ligands, the lowest energy excited electronic states are predominantly bipyridine based. For 1,2,3-triazole that is also the case, and it is affected by the nitrogen substitution of the triazole which renders the substituted triazole a worse σ donor than the 1,2,4 unsubstituted triazole. As a consequence a smaller ligand field for the 1,2,3-triazole-pyridine is expected which would cause a lowering of the metal centered triplet states (³MC) which are known to be thermally populated and efficient non-radiative channels for the depopulation of the luminescent ³MLCT state

For complex C1, the presence of 3-cyclodextrin strongly alters the photophysical behaviour compared with other derivates as adamantyl C5, as described in paper of De Cola et. al Chem. Eur. J. 2009, 15, 13124-13134. The emission maximum is unchanged, indicating the same nature and involvement of coordinated ligand, the emission quantum yields, for both air-equilibrated and deareated water solutions, dramatically increase. This is perhaps caused by the βCD, which could in some way interact with the cyclometallating ligands, partially keeping the water and the oxygen away from the Ir core.

The effects of the existence of two diastereoisomers of C1 in more detail have been described in the publication by De Cola et. al (Chem. Eur. J. 2009, 15, 13124-13134).

The applicant reports that the photophysical properties of these complexes as triplet long lifetimes, high emission quantum yields, and large Stokes shifts make them suitable for imaging applications and biolabeling. Furthermore the easy functionalization of the coordination sphere of the Ir complexes, modifying the coordinating ligand open the possibility of attaching biomolecules, like nucleic acids, amino acids, antibodies etc.

The complexes with β-CD can be used in aqueous solutions and provide an hydrophobic core and hydrophilic chains, wherein the hydrophobic core prevents the metal ion from any contact with water, but on the other hand biomolecules can be added to the hydrophilic chain.

The type of complexes described in this patent show an intense electrogenerated chemiluminescence in aprotic or aqueous buffer solutions. They meet the requirements for an effective use as ECL labels.,

As an example, the ECL intensity versus the potential of complexes C4. C1 and C5. (FIG. 8)

C4 shows an absolute ECL quantum yield of 41% in MeCN, while in water it is 0.34 relative to Ru(bpy)₃. C1 shows a 0.51 relative ECL quantum yield compare to Ru(bpy)₃.

The easy substitution on the triazole ring by click chemistry is an important property for the design of specific ECL biolabels.

The family of complexes described in the general formula by the applicant can be easily prepared, while the luminescence wavelength and intensity can be tuned by introducing substituents on the cyclometalating ligand or L3̂L2, respectively. For example, the presence of the β-cyclodextrin leads to species highly luminescent also in air-equilibrated water solutions, by reducing the sensitivity of Ir complexes to dioxygen. This opens new horizons for the preparation and application of new luminescent iridium complexes, for example, electrochemiluminescent device materials and labels for biomedical applications.

### EXAMPLES

### General Method

THF was purified by distillation under nitrogen from sodium/benzophenone and dry DMF was purchased from Fluka. The eluent called ‘magic mixture’ is a mixture of H₂O (300 mL), NaCl (30 g), acetonitrile (1200 mL), MeOH (300 mL). All other chemicals were purchased from Aldrich, Fluka or Acros and used as received. Analytical thin layer chromatography (TLC) was performed on Merck precoated silica gel 60 F-254 plates (layer thickness 0.25 mm) and the compounds visualised by ultraviolet (UV) irradiation at λ=254 nm and/or λ=366 nm and by staining with phosphomolybdic acid reagent or KMnO₄. Purifications by silica gel chromatography were performed using Acros (0.035-0.070 mm, pore diameter ca. 6 nm) silica gel. All click reactions were performed in oxygen-free atmosphere of N₂ using Schlenk conditions and distilled solvents.

### Nuclear Magnetic Resonance (NMR)

¹H NMR spectra were recorded, at 25° C., on a Varian Inova 400 or a Bruker DMX-300 machines operating at 400 and 300 MHz, respectively. ¹³C NMR spectra were recorded on a Bruker DMX-300 machine operating at 75 MHz. ¹H NMR chemical shifts (δ) are reported in parts per million (ppm) relative to a residual proton peak of the solvent, δ=3.31 for CD₃OD, δ=7.26 for CDCl₃ and δ=2.50 for DMSO. Multiplicities are reported as: s (singlet), d (doublet), t (triplet), q (quartet), dd (doublet of doublets), ddd (doublet of doublet of doublets), dt (doublet of triₚlets), or m (multiples). Broad peaks are indicated by b. Coupling constants are reported as a J value in Hertz (Hz). The number of protons (n) for a given resonance is indicated as nH, and is based on spectral integration values. ¹³C NMR chemical shifts (δ) are reported in ppm relative to a residual carbon peak of the solvent, δ=49.0 for CD₃OD, δ=77 for CDCl₃ and δ=40 for DMSO.

### Mass Spectrometry (MS)

High-Resolution mass spectrometry measurements were performed on a JEOL AccuTOF instrument (ESI) using water or methanol as solvents.

### Emission

Steady-state emission spectra were recorded on a HORIBA Jobin-Yvon IBH FL-322 Fluorolog 3 spectrometer equipped with a 450 W xenon arc lamp, double grating excitation and emission monochromators (2.1 nm mm⁻¹ dispersion; 1200 grooves mm⁻¹) and a TBX-4-X single-photon-counting detector. Emission spectra were corrected for source intensity (lamp and grating) and emission spectral response (detector and grating) by standard correction curves. Luminescence quantum yields (Φₑₘ) were measured in optically dilute solutions (O.D.<0.1 at excitation wavelength), using [Ru(bpy)₃]Cl₂ in aerated H₂O (Φₑₘ=0.028) or diphenylanthracene in cyclohexane (Φₑₘ=0.9) as references.

### Electrochemiluminescence

The annihilation ECL measurements were carried out in CH3CN solution with TBAPF6 as supporting electrolyte, under strictly aprotic conditions, in a one-compartment three electrode airtight cell, with high-vacuum O-rings and glass stopcocks. The working electrode consisted of a platinum side-oriented 2 mm diameter disk sealed in glass while the counter electrode was a platinum spiral and the reference electrode was a quasi-reference silver wire. Each time, two or three records were made to check the temporal stability of the system investigated. The annihilation reaction was obtained by pulsing the working electrode between the first oxidation and the first reduction peak potential of the complex with a pulse width of 0.1 s. For experiments in aqueous media, the reference electrode was a saturated KCl/Ag/AgCl electrode and ECL was generated by the addition of 30 mM DBAE (2-dibutylamino ethanol, from Sigma-Aldrich) as oxidative co-reactant in 0.1 M phosphate buffer solution. ECL was obtained in single oxidative steps by generating, at the same time, the amine and the Ir(III) complex in their oxidized forms according to known mechanisms. The ECL signal generated by performing the potential step program was measured with a photomultiplier tube (PMT, Hamamatsu R4220p) placed a few millimetres from the cell, and in front of the working electrode, inside a dark-box. A voltage in the range 250-750 V was supplied to the PMT. The light/current/voltages curves were recorded by collecting the preamplified PMT output signal (by a ultra-low noise Acton research mod. 181 by a Keithley Mod. 6485 picoamperometer) using the second input channel of the ADC module of the AUTOLAB instrument. ECL spectra have been recorded by inserting the same PMT in a dual exit monocromator (ACTON RESEARCH mod Spectra Pro2300i) and collecting the signal as described above. Photocurrent detected at PMT was accumulated for 1-3 seconds, depending on the emission intensity, for each monochromator wavelength step (usually 1 nm). Entrance and exit slits were fixed to the maximum value of 3 mm. The ECL efficiency was estimated by combining data from annihilation and chronoamperometric experiments and using the following relationship: ΦECL=ΦECLO (IQO/IOQ) Where Φ°ECL is the ECL efficiency of the standard under the same experimental conditions, I and I° are the integrated ECL intensity of the species and the standard systems, Q and Q° the faradaic charges (in Coulombs) measured during chronoamperometric experiments with the investigated species and the standard species, respectively. It has been estimated that the ECL efficiency can be confidently given with an error of ±15%. In order to obtain the ECL yields the measurements of a standard ECL system (i.e., 9,10 diphenylanthracene, which is among the most efficient ECL systems) in DCM solution, under the same experimental conditions as those used for the complexes, were performed and the ECL intensity ratio (IComplexes/IDPA) were determined From such an ECL intensity ratio, using the value of ECL annihilation efficiency of DPA (whose value, under similar experimental conditions, is reported to be 11%) the ECL yield of the complexes can be directly obtained

### SYNTHESIS OF THE IR DIMER USED IN THE EXAMPLES

The Ir(III) μ-chloro-bridged dimers (ppy)₂Ir(μ-Cl)₂Ir(ppy)₂, (F₂ppy)₂Ir(μ-Cl)₂Ir(F₂ppy)₂ and (piq)₂Ir(μ-Cl)₂Ir(piq)₂ were prepared according to literature procedures. S. Y. Park et al, J. Am. Chem. Soc. 2005, 127, 12438

### EXAMPLE OF SYNTHESIS OF SOME LIGANDS

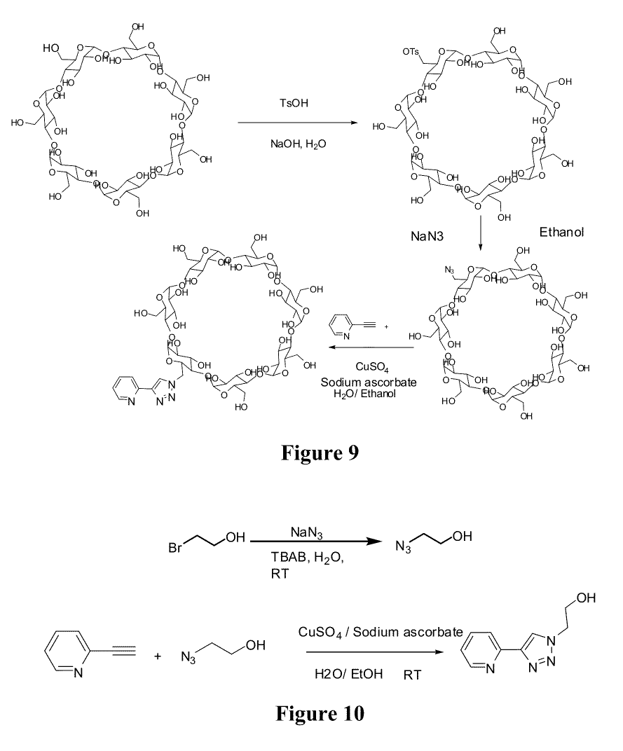

6-Op-Toluenesulfonyl-β-cyclodextrin was synthesized according to the literature methods Org. Synth. 2000, 77, 220. (FIG. 9)

6-O-Azido-β-cyclodextrin (2) was synthesized according to the literature methods, Anal. Chem. 2009, 81, 2895-2903 (FIG. 9)

pytl-β-CD was synthesized according to the modifying literature methods (Eur. J. Org. Chem. 2008, 5723-5730) (FIG. 9) 6-O-Azido-β-cyclodextrin (2) (2.01 g, 1.37 mmol) and 2-ethynylpyridine (0.18 mL, 1.71 mmol) were suspended in 1:1 H₂O-Ethanol (20 mL). To this was added CuSO₄.5H₂O (0.022, 0.088 mmol,) and sodium ascorbate (0.1 g, 0.504 mmol).

The mixture was stirred at room temperature for 24 h. After evaporation of the solvents, the crude product was dissolved in an ammonia solution (8%) and stirred overnight before being purified by column chromatography on silica gel with water as eluent. The product (3) was obtained as a white solid (1.13 g, 52%). HRMS (ES+): m/z calcd for C49H74N4O34: 1262.418; found: 1285.406 [M+Na]

Synthesis of 2-azidoethanol. (FIG. 10) Sodium azide (0.13 g, 2 mmol) and 2-bromoethanol (0.123 g 0.98 mmol), TBAB (0.98 mmol) were added to 10 ml H₂O solution, and mixtures were stirred at 80° C. for overnight. Crude mixtures were extracted by ether (3×20 ml). The combined organic extracts were dried (MgSO₄), filtered and solvent removed under reduced pressure to get product as a colorless oil. 1H NMR (300 MHz, CDCl3) δ 3.76 (s, 2H), 3.47-3.38 (m, 2H), 2.45 (s, 1H).

Synthesis of 2-(4-(pyridin-2-yl)-1H-1,2,3-triazol-1-yl)ethanol (FIG. 10). 2-azidoethanol (0.47 g, 5.42 mmol), 2-ethynylpyridine (0.55 g. 5.42 mmol) and sodium ascorbate (0.32 g, 1.62 mmol) were added to mixture of H₂O/EtOH (1:1) (40 mL). The mixture were purged by N2 for 10 min. CuSO₄.5H₂O (0.067 g, 5 mol %) was added into the mixture and purged for further 5 min. Rx was stirred at r.t. for 12 h. Solvent was removed by evaporation under reduced pressure. The crude compound was purified by column chromatography (EtOAc/MeOH, 3:1) to yield the product as light brown crystalline solid. 1H NMR (400 MHz, CDCl3) δ 8.52 (ddd, J=4.9, 1.8, 0.9 Hz, 1H), 8.32 (s, 1H), 8.14 (dt, J=8.0, 1.1 Hz, 1H), 7.79 (ddd, J=9.7, 6.6, 2.7 Hz, 1H), 7.25-7.22 (m, 1H), 4.61-4.53 (m, 2H), 4.18-4.11 (m, 2H), 3.48 (s, 1H). HRMS: Calcd. for C31H22F4IrN6O (M+Na)+: 213.0747; found 213.0748

### SYNTHESIS OF EXAMPLE COMPLEXES

Synthesis of C3. (FIG. 4) To a suspension of (piq)₂Ir(μ-Cl)₂Ir(piq)₂ (48.1 mg, 0.037 mmol) and 1′ (97.8 mg, 0.077 mmol) in CH₂Cl₂/Ethanol (1:3, 8 mL) was added. The suspension was heated to 80° C. and stirred for 6 hours, after which time a clear and orange solution was obtained. No workup was done and after removal of the solvent in vacuo, the solid obtained was purified by column chromatography (“magic mixture” eluent was a mixture of H₂O (300 mL), NaCl (30 g), acetonitrile (1200 mL), and MeOH (300 mL)). The product was obtained as an orange solid (4) (17.6 mg, 25%). HRMS (ES+): m/z calcd for C₇₉H₉₄N₆O₃₄Ir: 1863.5438; found: 1863.5408 M^{+.}

Synthesis of C8. A mixture of the (F2ppy)2Ir(μ-Cl)2Ir(F2ppy)2 (107 mg, 0.087 mmol) and the pyridinetriazole (69 mg, 0.1847 mmol) in 20 mL of DCM/EtOH (3:1, v/v) was refluxed for 5 h. The resulting solution was concentrated to dryness and the product purified by chromatography (DCM/MeOH 30:1 to 10:1). The complex was recrystallized in CHCl₃/hexanes at low temperature (−20° C.). 1H NMR (300 MHz, CDCl₃) δ 10.97 (s, 1H), 9.34 (d, J=7.4 Hz, 1H), 8.29 (d, J=9.3 Hz, 2H), 8.06 (t, J=6.9 Hz, 1H), 7.95-7.76 (m, 2H), 7.76-7.65 (m, 1H), 7.65-7.49 (m, 1H), 7.40 (d, J=5.4 Hz, 1H), 7.28 (dd, J=7.3, 5.7 Hz, 1H), 7.01 (dt, J=17.8, 6.3 Hz, 2H), 6.74-6.33 (m, 2H), 5.68 (ddd, J=22.6, 8.4, 2.3 Hz, 2H), 4.45 (t, J=6.9 Hz, 2H), 1.42-1.01 (m, 28H), 0.85 (t, J=6.7 Hz, 3H). 19F NMR (282 MHz, CDCl3) δ−105.54 (d, J=11.0 Hz), −106.48 (d, J=10.7 Hz), −108.51 (d, J=11.0 Hz), −109.47 (d, J=10.7 Hz).

Synthesis of C9 A mixture of 2-(4-(pyridin-2-yl)-1H-1,2,3-triazol-1-yl)ethanol (0.342 g, 1.8 mmol) and the (ppy)₂Ir(μ-Cl)₂Ir(ppy)₂ (0.7 g, 0.6 mmol) were stirred in dichloromethane (45 ml) and ethanol (15 ml) for 24 hours. The solvent was removed by evaporation under reduced pressure. The solid was separated using silica gel column chromatography (DCM: MeOH=3:1), giving a light-yellow complex (0.400 g, 87.4% yield). ¹H NMR (300 MHz, MeOD) δ 9.15 (s, 1H), 8.37 (dd, J=16.6, 8.2 Hz, 3H), 8.20 (td, J=7.8, 1.4 Hz, 1H), 8.05-7.93 (m, 3H), 7.78 (dd, J=27.6, 5.8 Hz, 2H), 7.57-7.49 (m, 1H), 7.26-7.13 (m, 2H), 6.78-6.58 (m, 2H), 5.74 (ddd, J=32.8, 8.6, 2.3 Hz, 2H), 4.55 (t, J=7.1 Hz, 2H), 3.52 (t, J=6.3 Hz, 2H), 1.95 (dt, J=14.3, 7.2 Hz, 2H).¹⁹F NMR (282 MHz, MeOD) δ−108.12 (d, J=10.7 Hz), −109.33 (d, J=10.3 Hz), −110.56 (d, J=10.8 Hz), −111.68 (d, J=10.3 Hz).

The described Cl salt of the complexes can be turn into the PF₆, BF₄ or ClO₄ salt by simple reaction with the NH₄PF₆, NaBF₄ or NaClO₄ water saturated solutions and the corresponding complex.

1. The use of a luminescent complex according to the general formula I 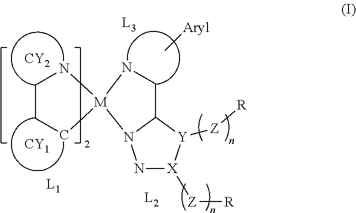
in an aqueous solution, wherein
M represents Ru(II) or Ir(III), and
L₁ represents a cyclometalating ligand, wherein each of CY₁ and CY₂ comprises at least one aromatic and/or aliphatic ring, and
L₂ represents triazole, tetrazole or pyrazole, and
L₃ represents a pyridine with or without fused and non-fused ring, and
X represents C or N, and
Y represents C or N, and
Z represents C—O—C, an alkyl, aryl, alkynyl, CH═CH, CF₂, and
R represents H, a halogen, OH, COOH, C(O)OR′, C(O)NR SO₃⁻, SO₄⁻, NR′₂, NR′₃⁺,
OR′, aromatic ring or ring systems, non-aromatic ring or ring systems, heteroaromatic ring or ring systems, imidazolium, cyclodextrin, with R′ representing H, an alkyl or aryl.

2. The use according to claim 1, wherein the cyclometalating ligands are selected from the group comprising pyridine, bipyridine, phenyl-pyridine, phenyl-isoquinoline, 2,4-bisfluor-phenyl-pyridine, and any ligand comprising an aryl-heterocyclic aromatic ring and/or an aryl-heterocyclic non-aromatic ring.

3. The use according to claim 1, wherein the substituted pyridine-heteroaromatic rings is 2-(3-substituted-1H-1,2,4-triazole-5-yl)pyridine, 2-(4-substituted-1,2,3-triazole-4-yl)pyridine or 2-(1-substituted-1,2,3-triazole-4-yl)pyridine.

4. The use according to claim 1, wherein the pyridine- heteroaromatic rings is 2-(3-substituted-1H-pyrazole-5-yl)pyridine.

5. The use according to claim 2, wherein the cyclodextrine is a β-cyclodextrin.

6. The use according to claim 2, wherein the mono-functionalized cyclodextrin is permethylated.

7. The use according to claim 1, wherein the complex is coupled to a biological substance, a biological molecule or a synthetic substance or molecule.

8. The use according to claim 7, wherein the substances or molecules are coupled with a hydrophilic chain of the complex.

9. The use according to claim 1, wherein the complex is coupled to a cell, an antibody, a polypeptide, an amino acid, a deoxyribonucleic acid, a ribonucleic acid, a polysaccharide, an alkaloid, a steroid, a vitamin, a synthetic or biological polymer, or to a synthetic or biological surface.

10. The use according to claim 1 in a chemi- or electrochemiluminescent device or a chemi or electrochemiluminescent system.

11. The use according to claim 1 for the detection of cells, antibodies, polypeptides, amino acids, deoxyribonucleic acids, ribonucleic acids, polysaccharides, alkaloids, steroids, vitamins, synthetic or biological polymers.

12. The use according to claim 1 in screening, detection, binding or competitive binding assays.
